(19) United States
(12) Patent Application Publication
(10) Pub. No.: US 2013/0083282 A1
(43) Pub. Date: Apr. 4, 2013

(54) LIQUID CRYSTAL DISPLAY DEVICE AND INFORMATION TERMINAL INCLUDING THE SAME

(71) Applicants: Toshiaki YOSHIHARA, Sagamihara (JP); Yoshihisa Kurosaki, Setagaya (JP)

(72) Inventors: Toshiaki YOSHIHARA, Sagamihara (JP); Yoshihisa Kurosaki, Setagaya (JP)

(73) Assignee: FUJITSU LIMITED, Kawasaki-shi (JP)

(21) Appl. No.: 13/525,556

(22) Filed: Jun. 18, 2012

(30) Foreign Application Priority Data
Sep. 30, 2011 (JP) 2011-216392

(51) Int. Cl. G02F 1/1339

(52) U.S. Cl. 349/154

(57) ABSTRACT

A liquid crystal display device includes a first substrate, a second substrate opposite to the first substrate, a sealant provided between the first substrate and the second substrate to define a display area to be filled with a liquid crystal and a liquid crystal injection port defined by the first substrate, the second substrate and the sealant, wherein regions where the first substrate, the second substrate and the sealant are positioned on a same plane are provided on opposite sides of the liquid crystal injection port, each of the regions where the first substrate, the second substrate and the sealant are positioned on the same plane having a length equal to 0.26e^{0.64Ra} (mm) or more from the liquid crystal injection port, where surface roughness of the regions where the first substrate, the second substrate and the sealant are positioned on the same plane is Ra (μm).

### CROSS-REFERENCE TO RELATED APPLICATION

This application is based upon and claims the benefit of priority of the prior Japanese Patent Application No. 2011-216392, filed on Sep. 30, 2011, the entire contents of which are incorporated herein by reference.

### FIELD

The embodiment discussed herein is related to a liquid crystal display device and an information terminal including the liquid crystal display device.

### BACKGROUND

In recent years, liquid crystal display devices such as electronic paper have been actively developed in enterprises and universities. Applications of, for example, electronic paper to various information terminals including, first of all, electronic books and also sub-displays of mobile terminals and display units of IC cards have been proposed.

A liquid crystal display device has a structure in which a liquid crystal sandwiched between two substrates is surrounded and sealed by a sealant. When a liquid crystal display device having such a structure is produced, a vacuum injection method is used as a method of filling a display area defined by the two substrates and the sealant with a liquid crystal.

### SUMMARY

According to an aspect of the embodiment, a liquid crystal display device and an information terminal include: a first substrate; a second substrate opposite to the first substrate; a sealant provided between the first substrate and the second substrate to define a display area to be filled with a liquid crystal; and a liquid crystal injection port defined by the first substrate, the second substrate and the sealant, wherein regions where the first substrate, the second substrate and the sealant are positioned on a same plane are provided on opposite sides of the liquid crystal injection port, each of the regions where the first substrate, the second substrate and the sealant are positioned on the same plane having a length equal to 0.26e^{0.64Ra} (mm) or more from the liquid crystal injection port, where surface roughness of the regions where the first substrate, the second substrate and the sealant are positioned on the same plane is Ra (μm).

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a configuration of a display unit included in a liquid crystal display device according to the present embodiment;

FIG. 2 is a schematic sectional view illustrating the configuration of the display unit included in the liquid crystal display device according to the present embodiment;

FIG. 3 is a schematic diagram illustrating the configuration of the liquid crystal display device according to the present embodiment;

FIGS. 4A and 4B are schematic diagrams illustrating the principle of display of the liquid crystal display device using a cholesteric liquid crystal according to the present embodiment;

FIG. 5 is a diagram illustrating a definition of surface roughness on the liquid crystal display device according to the present embodiment;

FIG. 6 is a diagram illustrating a measuring method of the surface roughness on the liquid crystal display device according to the present embodiment;

FIG. 7 is a diagram illustrating the measuring method of a liquid crystal spread distance;

FIG. 8 is a diagram illustrating a relationship between the surface roughness and the liquid crystal spread distance;

FIG. 9 is a schematic diagram illustrating the configuration of an information terminal according to the present embodiment;

FIG. 10 is a schematic diagram illustrating the configuration of a modification of the display unit included in the liquid crystal display device according to the present embodiment; and

FIG. 11 is a schematic diagram illustrating an object of the present invention.

### DESCRIPTION OF EMBODIMENTS

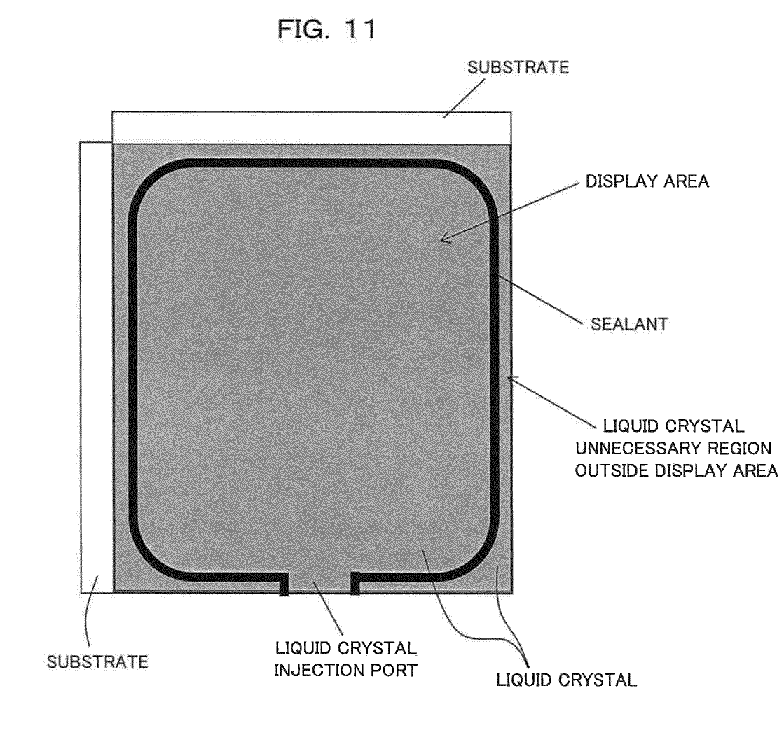

In a liquid crystal injection process in which a display area is filled with a liquid crystal through a liquid crystal injection port by the above vacuum injection method, as illustrated, for example, in FIG. 11, the liquid crystal enters a region outside the display area that needs not be filled with the liquid crystal, that is, a region outside a sealant. Then, if the liquid crystal enters the region outside the display area, a cleaning process to wash out the unnecessary liquid crystal will be needed after the liquid crystal injection process, leading to higher costs. Moreover, if cleaning of the liquid crystal is insufficient, corrosion of electrodes or terminals is caused, leading to lower quality or reliability.

Thus, costs are preferably reduced and quality and reliability are preferably improved by preventing the liquid crystal from entering the region outside the display area.

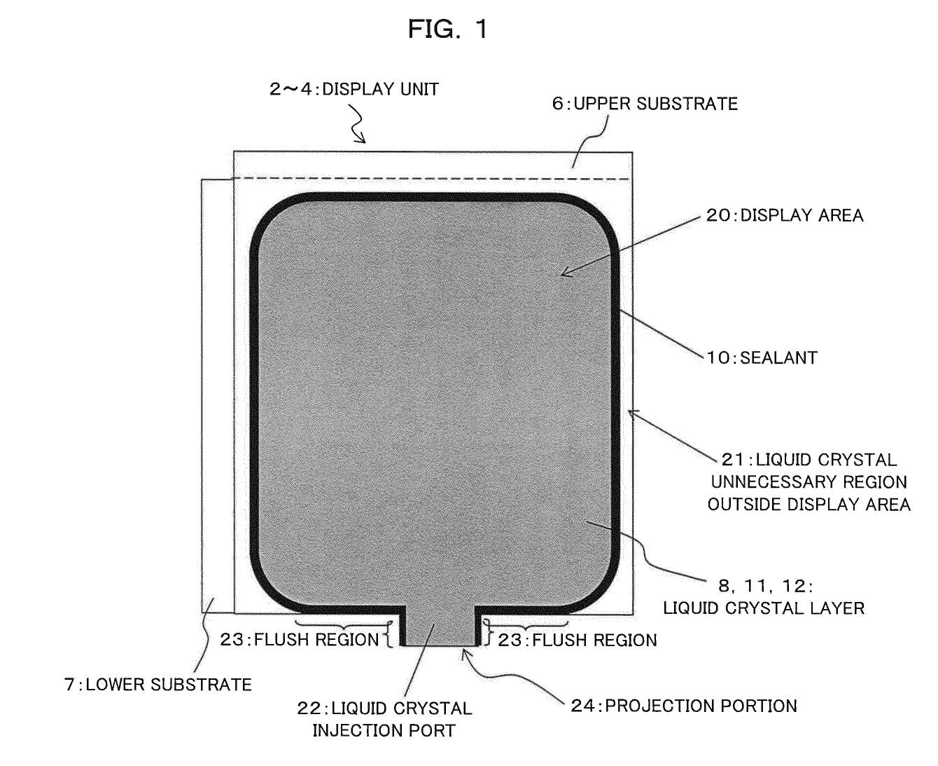

A liquid crystal display device according to an embodiment and an information terminal including the liquid crystal display device will be described below using the drawings with reference to FIGS. 1 to 9.

The liquid crystal display device according to the present embodiment is for example, electronic paper using a cholesteric liquid crystal. The liquid crystal display device is also called a liquid crystal display apparatus or a display apparatus.

The cholesteric liquid crystal is a liquid crystal composition in which a cholesteric phase is formed and is appropriately used for a display unit of electronic paper, for example. The cholesteric liquid crystal has such superior features as semipermanent display holding properties (memory properties), clear color display properties, high contrast properties, and high resolution properties. Details thereof will be described later.

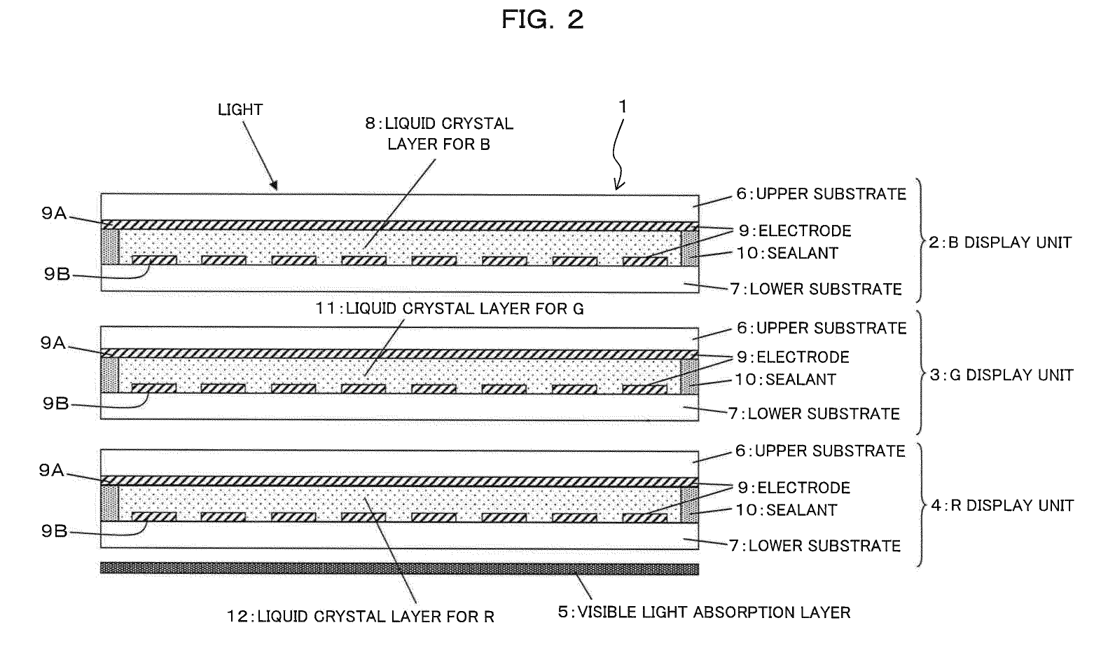

The liquid crystal display device is, as illustrated in FIG. 2, a liquid crystal display device 1 capable of making a full-color display by using cholesteric liquid crystals for blue (B), green (G) and red (R), and has a structure in which a blue (B) display unit 2, a green (G) display unit 3, and a red (R) display unit 4 are stacked from the side of a light incidence plane (display face) in this order. In the present embodiment, a visible light absorption layer (light absorption layer) 5 is also provided below the R display unit 4. In FIG. 2, the upper side is the display face, and external light is incident from the upper side toward the display face. The display unit may also be called a panel.

Among these display units, the B display unit 2 includes a pair of an upper substrate 6 and a lower substrate 7 placed opposite to each other, a blue liquid crystal layer 8 that reflects blue light in a planar state, electrodes 9 to apply a voltage to a liquid crystal, and a sealant 10 that seals the liquid crystal filled between both substrates.

The B liquid crystal layer 8 is formed by encapsulating a cholesteric liquid crystal for B adjusted to selectively reflect blue in a region (display area) 20 surrounded by the upper substrate 6, the lower substrate 7 and the sealant 10 (see FIG. 1). That is, the B liquid crystal layer 8 is sandwiched between the upper substrate 6 and the lower substrate 7, and an outer circumference thereof is sealed by the sealant 10.

The G display unit 3 includes the pair of the upper substrate 6 and the lower substrate 7 placed opposite to each other, a green (G) liquid crystal layer 11 that reflects green light in a planar state, the electrodes 9 to apply a voltage to a liquid crystal, and the sealant 10 that seals the liquid crystal filled between both substrates.

The G liquid crystal layer 11 is formed by encapsulating a cholesteric liquid crystal for G adjusted to selectively reflect green in the region (display area) 20 surrounded by the upper substrate 6, the lower substrate 7 and the sealant 10 (see FIG. 1). That is, the G liquid crystal layer 11 is sandwiched between the upper substrate 6 and the lower substrate 7, and the outer circumference thereof is sealed by the sealant 10.

The R display unit 4 includes the pair of the upper substrate 6 and the lower substrate 7 placed opposite to each other, a red (R) liquid crystal layer 12 that reflects red light in a planar state, the electrodes 9 to apply a voltage to a liquid crystal, and the sealant 10 that seals the liquid crystal filled between both substrates.

The R liquid crystal layer 12 is formed by encapsulating a cholesteric liquid crystal for R adjusted to selectively reflect red in the region (display area) 20 surrounded by the upper substrate 6, the lower substrate 7 and the sealant 10 (see FIG. 1) That is, the R liquid crystal layer 12 is sandwiched between the upper substrate 6 and the lower substrate 7, and the outer circumference thereof is sealed by the sealant 10.

The upper substrate 6 and the lower substrate 7 of each of the display units 2 to 4 are substrates having translucency. A polycarbonate (PC) film substrate is used in the present embodiment. Instead of the PC substrate as a plastic film substrate, a glass substrate or a plastic film substrate of polyethylene terephthalate (PET) or polyethylene naphthalate (PEN) may be used. In the present embodiment, each of the upper substrate 6 and the lower substrate 7 is assumed to have translucency, but the lower substrate 7 of the R display unit 4 placed in the lowest layer may be non-translucent.

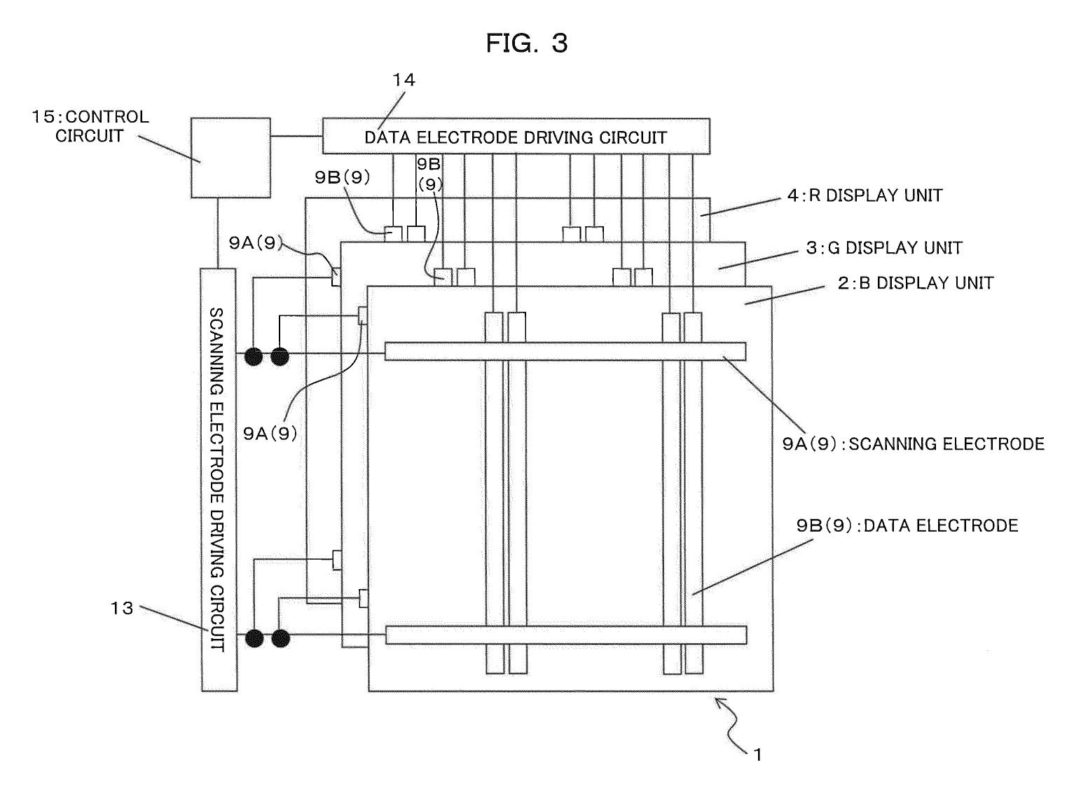

The electrodes 9 of each of the display units 2 to 4 are a scanning electrode 9A and a data electrode 9B. In the present embodiment, a plurality of band-like scanning electrodes 9A extending in the left and right direction in FIG. 3 are provided in parallel on the side of the liquid crystal layer of the upper substrate 6 of each of the display units 2 to 4. Further, a plurality of band-like data electrodes 9B extending in the up and down direction in FIG. 3 are provided in parallel on the side of the liquid crystal layer of the lower substrate 7 of each of the display units 2 to 4. The scanning electrode 9A and the data electrode 9B of each of the display units 2 to 4 are placed opposite to each other on the surfaces opposite to each other of the upper substrate 6 and the lower substrate 7, respectively, so as to cross each other when electrode forming surfaces of the upper substrate 6 and the lower substrate 7 are viewed from the normal direction. Thus, each crossing region of the scanning electrode 9A and the data electrode 9B becomes a pixel and a display screen in which a plurality of pixels are arranged in a matrix shape is formed. A portion provided in each crossing region of the scanning electrode 9A and the data electrode 9B is called a pixel electrode. In this case, the plurality of scanning electrodes 9A and the plurality of data electrodes 9B are provided by patterning a transparent electrode to enable the QVGA display of 320×240 dots. For example, indium tin oxide (ITO) is typically used as the formation material of these scanning electrodes 9A and data electrodes 9B and in addition, indium zinc oxide (IZO) or a transparent conducting film such as a silver nano-wire may be used.

Though not illustrated, an alignment layer formed of, for example, polyimide resin is preferably provided on each of these scanning electrodes 9A and data electrodes 9B to control the arrangement of liquid crystal molecules.

Scanning electrode drive circuit 13 on which a scanning electrode driver IC to drive the plurality of scanning electrodes 9A of each of the display units 2 to 4 is mounted is connected to the plurality of scanning electrodes 9A. In the present embodiment, the scanning electrode drive circuit 13 includes a common scanning electrode driver IC as the scanning electrode driver IC to drive the scanning electrodes 9A of each of the display units 2 to 4. Thus, without providing a respective scanning electrode driver IC to drive each of the scanning electrodes 9A of each of the display units 2 to 4, the configuration of the scanning electrode drive circuit 13 is simplified. Incidentally, the scanning electrode driver IC may be made common when needed and a scanning electrode driver IC may be provided a respective scanning electrode driver IC to drive each of the scanning electrodes 9A of each of the display units 2 to 4.

Data electrode drive circuit 14 on which a data electrode driver IC to drive the plurality of data electrodes 9B of each of the display units 2 to 4 is mounted is connected to the plurality of data electrodes 9B. In the present embodiment, the data electrode drive circuit 14 includes a respective data electrode driver IC to drive each of the data electrodes 9B of each of the display units 2 to 4.

The scanning electrode drive circuit 13 and the data electrode drive circuit 14 output a scanning signal or a data signal to the predetermined scanning electrode 9A or data electrode 9B based on a predetermined signal output from a control circuit 15 respectively. Accordingly, a predetermined pulse voltage is applied to each of the liquid crystal layers 8, 11, 12.

The sealant 10 of each of the display units 2 to 4 is provided, as illustrated in FIGS. 1 and 2, between the upper substrate 6 and the lower substrate 7 along the outer circumference of the upper substrate 6 and the lower substrate 7. The liquid crystal sandwiched between the upper substrate 6 and the lower substrate 7 is sealed by the sealant 10. That is, the display area 20 filled with the liquid crystal is defined by the sealant 10. Because the sealant 10 is provided in peripheral portions of the upper substrate 6 and the lower substrate 7, the sealant 10 may also be called a peripheral seal.

Though not illustrated, a spacer is provided in each of the liquid crystal layers 8, 11, 12 of each of the display units 2 to 4 to maintain the thickness, that is, to uniform the cell gap of each of the liquid crystal layers 8, 11, 12 of each of the display units 2 to 4. For example, spherical spacers made of resin or inorganic oxide may be dispersed and formed or a plurality of columnar spacers from a structure may be formed. The cell gap d of each of the liquid crystal layers 8, 11, 12 is preferably about 3 μm≦d≦about 6 μm.

Incidentally, the liquid crystal composition constituting the B, G, F liquid crystal layers 8, 11, 12 is a cholesteric liquid crystal prepared by adding a relatively large amount of several tens of wt % in content of a chiral additive (also called a chiral material) to a nematic liquid crystal mixture. In the present embodiment, the liquid crystal composition is a cholesteric liquid crystal prepared by adding about 10 to about 40 wt % of chiral material to a nematic liquid crystal mixture. The amount of addition of the chiral material is a value when the total amount of the nematic liquid crystal component and the chiral material is 100 wt %. By including a relatively large amount of chiral material in the nematic liquid crystal in this manner, nematic liquid crystal molecules can be made to a cholesteric liquid crystal in which a cholesteric phase created by nematic liquid crystal molecules being strongly twisted in a helical fashion is formed. Thus, the cholesteric liquid crystal is also called a chiral nematic liquid crystal. Various publicly-known nematic liquid crystals can be used as the nematic liquid crystal. The refractive index anisotropy (Δn) is preferably in the range of about 0.18 to about 0.24. If the refractive index anisotropy (Δn) is smaller than this range, the reflectivity in a planar state decreases. If the refractive index anisotropy (Δn) is larger than this range, the scatter reflection in a focal conic state Increases and also the viscosity increases, leading to a slower response speed. Further, the thickness of the liquid crystal is preferably about 3 μpm to about 6 μm and if the thickness is thinner than the range, the reflectivity in a planar state decreases. If the thickness is thicker than the range, the drive voltage becomes too high.

Such a cholesteric liquid crystal has bistability (memory properties), and can be in a planar state, focal conic state, or an intermediate state that these states mix, by controlling an electric field intensity applied to the liquid crystal. Then, once the cholesteric liquid crystal is in a planar state, focal conic state, or an intermediate state, the cholesteric liquid crystal can thereafter maintain the state with stability in a state without electric field.

The planar state can be obtained by, for example, applying a predetermined high voltage to between the upper and lower substrates to apply a strong electric field to the liquid crystal layer and after the liquid crystal being brought into a homeotropic state, reducing the electric field rapidly to zero. The focal conic state can be obtained by, for example, applying a predetermined voltage lower than the above high voltage to between the upper and lower substrates to apply an electric field to the liquid crystal layer and then, reducing the electric field rapidly to zero. The focal conic state can also be obtained by gradually applying a voltage from a planar state. An intermediate state between the planar state and the focal conic state can be obtained by, for example, applying a voltage lower than the voltage at which a focal conic state can be obtained to between the upper and lower substrates to apply an electric field to the liquid crystal layer and then, reducing the electric field rapidly to zero.

Next, the principle of display of the liquid crystal display device 1 using such a cholesteric liquid crystal will be described by taking the B display unit 2 as an example.

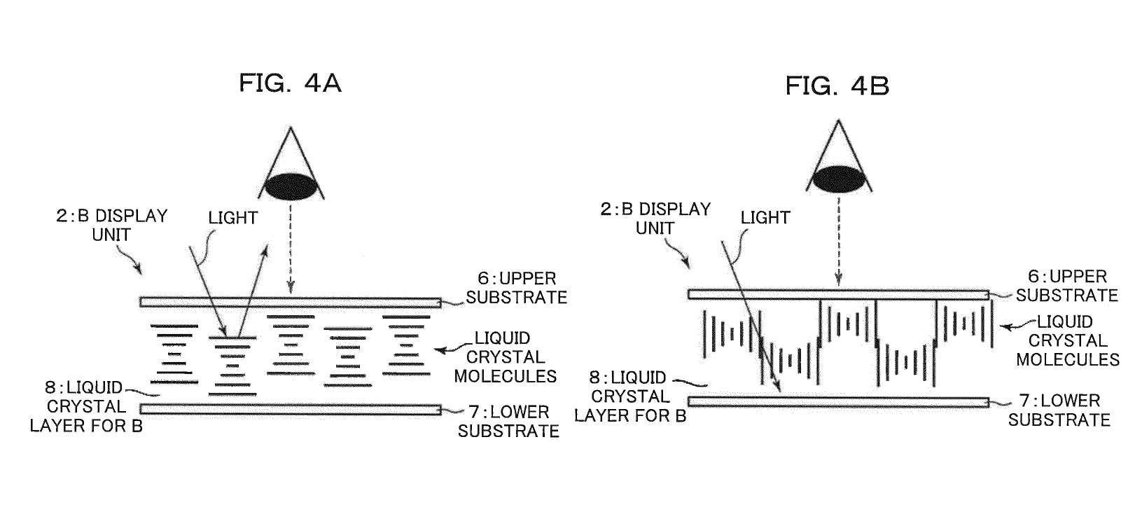

First, FIG. 4A illustrates an alignment state of liquid crystal molecules of the cholesteric liquid crystal when the B liquid crystal layer 8 of the B display unit 2 is in a planar state.

As illustrated in FIG. 4A, liquid crystal molecules in the planar state form a helical structure by sequentially being rotated in the substrate thickness direction and the helical axis of the helical structure is approximately perpendicular to the substrate face.

In the planar state, light of predetermined wavelengths in accordance with the helical pitch of liquid crystal molecules is selectively reflected by the liquid crystal layer 8. Where the average refractive index of the liquid crystal layer 8 is n and the helical pitch thereof is p, the wavelength at which the reflection is maximum is expressed as λ=n·p. Therefore, to cause the liquid crystal layer 8 of the B display unit 2 to selectively reflect blue light in a planar state, the average refractive index n and the helical pitch p are decided so as to be, for example, λ=480 nm. The average refractive index n can be adjusted by selecting the liquid crystal material and the chiral material and the helical pitch p can be adjusted by adjusting the content rate of the chiral material.

Next, FIG. 4B illustrates the alignment state of liquid crystal molecules of the cholesteric liquid crystal when the B liquid crystal layer 8 of the B display unit 2 is in a focal conic state.

As illustrated in FIG. 4B, liquid crystal molecules in the focal conic state form a helical structure by sequentially being rotated in the substrate in-plane direction and the helical axis of the helical structure is approximately parallel to the substrate face. In the focal conic state, selectivity of the reflected wavelength is lost to the B liquid crystal layer 8 and almost all incident light is transmitted. In the present embodiment, transmitted light is absorbed by the visible light absorption layer 5 arranged on the back face side (outside face side) of the lower substrate 7 of the R display unit 4 (see FIG. 2).

In an intermediate state between the planar state and the focal conic state, the ratio of reflected light and transmitted light can be adjusted in accordance with the state thereof and thus the intensity of the reflected light can be varied.

Thus, in a cholesteric liquid crystal, the reflection amount of light can be controlled by the alignment state of liquid crystal molecules twisted in a helical fashion.

Such a cholesteric liquid crystal that selectively reflects blue light in a planar state is used for the B liquid crystal layer 8 of the B display unit 2. Similarly, a cholesteric liquid crystal that selectively reflects green light in a planar state is used for the G liquid crystal layer 11 of the G display unit 3. Further, a cholesteric liquid crystal that selectively reflects red light in a planar state is used for the R liquid crystal layer 12 of the R display unit 4. Then, by stacking the liquid crystal layers 8, 11, 12 that selectively reflect blue, green, and red lights (see FIG. 2) and using selective reflection characteristics of the cholesteric liquid crystal, the liquid crystal display device 1 consuming no power except when rewriting the screen and capable of making a full-color display with memory properties can be realized.

In a stacked structure of the display units 2 to 4 of B, G, R, it is preferable to make optical activity of the G liquid crystal layer 11 and that of the B, R liquid crystal layers 8, 12 in a planar state different. Accordingly, losses of reflected light can be reduced to improve brightness of the display screen of the liquid crystal display device 1.

Also in the present embodiment, the visible light absorption layer 5 is arranged on the back face side of the lower substrate 7 of the R display unit 4 and when the liquid crystal layers 8, 11, 12 of B, G, R are all in the focal conic state, transmitted light is absorbed by the visible light absorption layer 5 and black is displayed on the display screen of the liquid crystal display device 1. The visible light absorption layer 5 may be provided when needed.

The display units 2 to 4 of the liquid crystal display device 1 configured as described above can be produced as described below.

First, a plurality of scanning electrodes 9A and a plurality of data electrodes 9B are formed on the surfaces of the two substrates 6, 7 respectively (see FIG. 2). After this process, an alignment layer may be formed on the respective substrates 6, 7 or spacers may be formed when needed.

Next, the two substrates 6, 7 are bonded together by the sealant 10 provided in a peripheral portion of one of the substrates 6 (7) (see FIG. 2). Accordingly, the display area 20 to be filled with the liquid crystal is defined by the upper substrate 6, the lower substrate 7 and the sealant 10 (see FIG. 1).

Next, the display area 20 defined by the upper substrate 6, the lower substrate 7 and the sealant 10 is filled with the liquid crystal by the vacuum injection method (see FIG. 1). When, for example, the B display unit 2 is produced, a B liquid crystal is injected through a liquid crystal injection port 22 in the liquid crystal injection process to fill the display area 20 with the B liquid crystal. When the G display unit 3 is produced, a G liquid crystal is injected through the liquid crystal injection port 22 in the liquid crystal injection process to fill the display area 20 with the G liquid crystal. When the R display unit 4 is produced, an R liquid crystal is injected through the liquid crystal injection port 22 in the liquid crystal injection process to fill the display area 20 with the R liquid crystal.

Then, after the display area 20 being filled with the liquid crystal, though not illustrated, the liquid crystal injection port 22 is sealed by a sealant.

In this manner, the display units 2 to 4 of the liquid crystal display device 1 configured as described above can be produced.

Incidentally, various examinations to prevent the liquid crystal from entering a liquid crystal unnecessary region outside the display area 20 as illustrated in FIG. 11 when the display units 2 to 4 of the liquid crystal display device 1 are produced as described above revealed the following.

First, as illustrated in FIG. 3 the spread of the liquid crystal during injection of the liquid crystal can be suppressed by making the upper substrate 6, the lower substrate 7 and the sealant 10 exposed on opposite sides of the liquid crystal injection port 22 in the liquid crystal injection process flush with each other. That is, the spread of the liquid crystal during injection of the liquid crystal can be suppressed by providing regions where the upper substrate 6, the lower substrate 7 and the sealant 10 are positioned on a same plane on opposite sides of the liquid crystal injection port 22 in the liquid crystal injection process.

Next, the relationship between surface roughness Ra (μm) of regions where the upper substrate 6, the lower substrate 7 and the sealant 10 are made flush with each other, that is, regions where the upper substrate 6, the lower substrate 7 and the sealant 10 are positioned on the same plane, and the liquid crystal spread distance (mm) is examined.

Three liquid crystal materials of different compositions, that is, an R cholesteric liquid crystal, a G cholesteric liquid crystal, and a B cholesteric liquid crystal are used as liquid crystal materials.

A film substrate is used as the upper substrate 6 and the lower substrate 7, and the upper substrate 6, the lower substrate 7 and the sealant 10 are positioned on the same plane by simultaneously cutting the upper substrate 6, the lower substrate 7 and the sealant 10 while the upper substrate 6 and the lower substrate 7 are bonded by the sealant 10. Thus, the surface roughness Ra of the regions where the upper substrate 6, the lower substrate 7 and the sealant 10 are positioned on the same plane is the surface roughness of a cut surface of the upper substrate 6, the lower substrate 7 and the sealant 10. Then, the surface roughness Ra of the regions where the upper substrate 6, the lower substrate 7 and the sealant 10 are positioned on the same plane is adjusted by changing the blade used to cut the upper substrate 6, the lower substrate 7 and the sealant 10 simultaneously to the Thomson blade, ring cutters (double-edged, single-edged), or scissors.

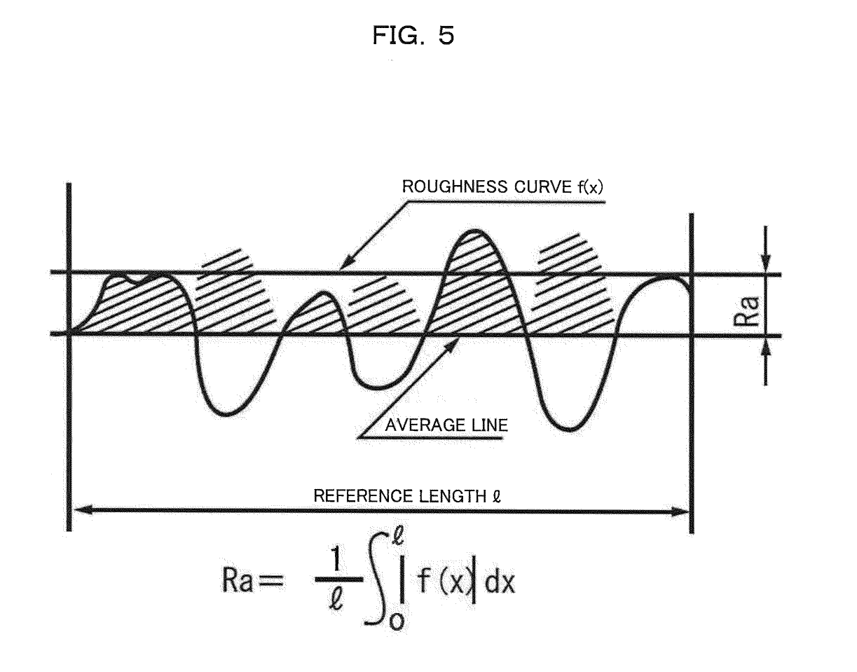

The surface roughness Ra is the surface roughness (arithmetic average roughness) defined by JIS B0601-1994. That is, the surface roughness Ra is, as illustrated in FIG. 5, a value determined by the formula illustrated in FIG. 5 when, as illustrated in FIG. 5, a reference length l in the direction of an average line is extracted from a roughness curve f (x) and y=f (x) is represented by setting the X axis in the direction of the average line of the extracted portion and the Y axis in the direction of longitudinal magnification.

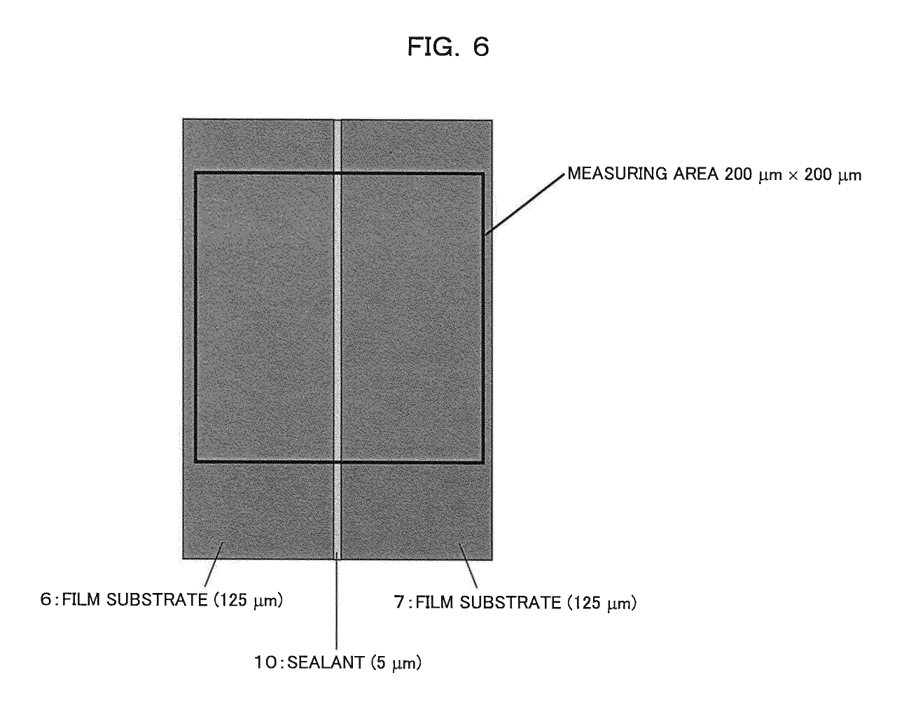

The measurement of the surface roughness Ra of the regions where the upper substrate 6, the lower substrate 7 and the sealant 10 are positioned on the same plane is made using a laser microscope (Keyence, VK-9700). More specifically, as illustrated in FIG. 6, the thickness of the film substrate as the upper substrate 6 and the lower substrate 7 is set to about 125 μm and the thickness of the sealant 10 is set to about 5 μm. Then, the surface roughness Ra of the regions where the upper substrate 6, the lower substrate 7 and the sealant 10 are positioned on the same plane is measured by simultaneously measuring these cut surfaces using the laser microscope (Keyence, VK-9700) with the measuring area set as about 200 μm×about 200 μm.

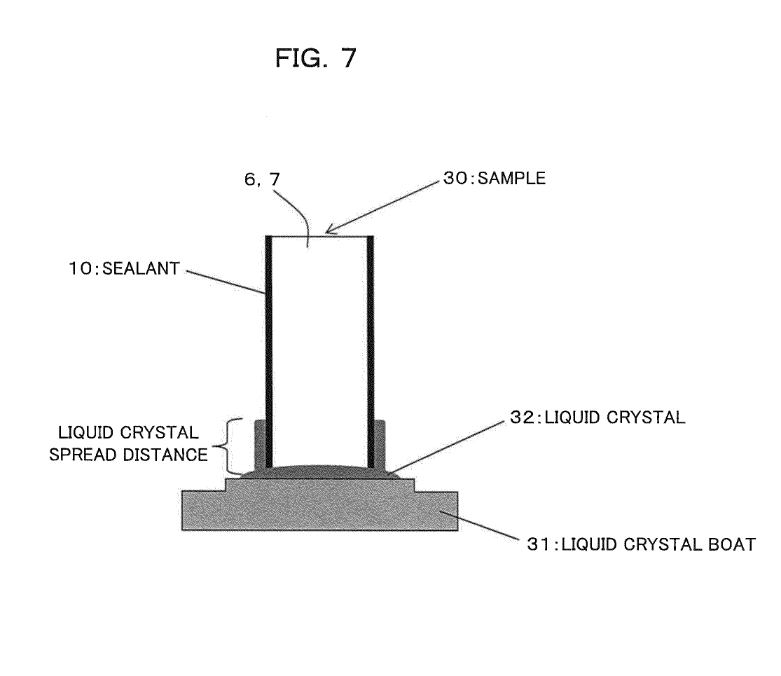

As illustrated in FIG. 7, samples 30 with different surface roughness Ra of the regions where the upper substrate 6, the lower substrate 7 and the sealant 10 are positioned on the same plane (flush regions) are prepared and a liquid crystal 32 on a liquid crystal boat 31 is brought into contact with ends of flush regions of each of the samples 30 to examine a liquid crystal spread distance after 48 hours. FIG. 7 illustrates a state in which the upper substrate 6, the sealant 10, and the lower substrate 7 are stacked in a direction perpendicular to the paper surface and thus, the regions where the upper substrate 6, the lower substrate 7 and the sealant 10 are positioned on the same plane are located on the left and right sides of the sample 30.

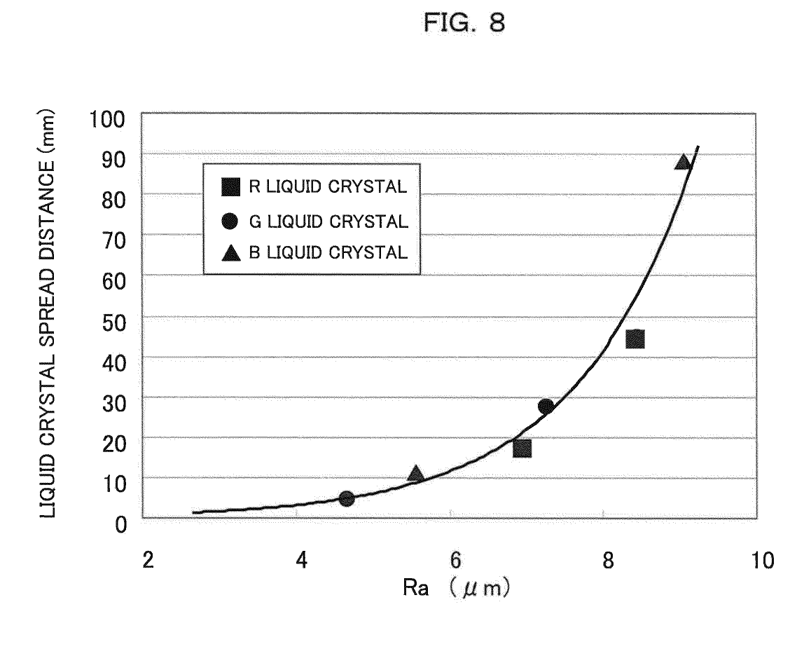

As a result, the relationship illustrated in FIG. 8, that is, an approximation formula represented by y=0.26e^{0.64x} (e: base of natural logarithm) is obtained. Namely, it turned out that there is a strong correlation between the surface roughness Ra (μm) of the regions where the upper substrate 6, the lower substrate 7 and the sealant 10 are positioned on the same plane and the liquid crystal spread distance (mm) and the liquid crystal spread distance can be represented as 0.26e^{0.64Ra}. It also turned out that the liquid crystal spread distance increases rapidly when the surface roughness Ra exceeds about 8 μm.

Thus, in the present embodiment, the display units 2 to 4 of the liquid crystal display device 1 are configured as described below.

That is, in the present embodiment, the display units 2 to 4 of the liquid crystal display device 1 include, as illustrated in FIG. 1, the liquid crystal injection port 22 defined by the upper substrate 6, the lower substrate 7 and the sealant 10. Namely, the upper portion of the liquid crystal injection port 22 is defined by an end face of the upper substrate 6, the lower portion thereof is defined by an end face of the lower substrate 7 and each of side portions thereof is defined by an end face of the sealant 10. The upper substrate 6, the lower substrate 7 and the sealant 10 are exposed on opposite sides of the liquid crystal injection port 22 of the display units 2 to 4 of the liquid crystal display device 1, and the upper substrate 6, the lower substrate 7 and the sealant 10 sandwiched between the substrates 6, 7 are positioned on the same plane. The length of each of regions 23 where the upper substrate 6, the lower substrate 7 and the sealant 10 are positioned on the same plane from the liquid crystal injection port 22 is a length of about 0.26e^{0.64Ra} (mm) or more, where the surface roughness of the regions 23 where the upper substrate 6, the lower substrate 7 and the sealant 10 are positioned on the same plane is Ra (μm). That is, the upper substrate 6, the lower substrate 7 and the sealant 10 on opposite sides of the liquid crystal injection port 22 are positioned on the same plane, and the length of each of the regions 23 where the upper substrate 6, the lower substrate 7 and the sealant 10 are positioned on the same plane from the liquid crystal injection port 22 is about 0.26e^{0.64Ra} (mm) or more, where the surface roughness of the regions 23 where the upper substrate 6, the lower substrate 7 and the sealant 10 are positioned on the same plane is Ra (μm).

More specifically, the display units 2 to 4 of the liquid crystal display device 1 are defined by the upper substrate 6, the lower substrate 7 and the sealant 10, and include a projection portion 24 having the liquid crystal injection port 22 at an end thereof. The projection portion 24 of each of the display units 2 to 4 is defined by a projection portion of the upper substrate 6, a projection portion of the lower substrate 7 opposite thereto and the sealant 10 each provided between the side portions of the projection portion of the upper substrate 6 and the side portions of the projection portion of the lower substrate 7 along the side portions of the upper substrate 6 and the lower substrate 7. The upper portion of the end of the projection portion 24 is defined by the end face of the upper substrate 6, the lower portion thereof is defined by the end face of the lower substrate 7, and each of the side portions thereof is defined by the end face of the sealant 10, and the liquid crystal injection port 22 is located on the end of the projection portion 24. In this case, the regions 23 where the upper substrate 6, the lower substrate 7 and the sealant 10 are positioned on the same plane include side faces, where the upper substrate 6, the lower substrate 7 and the sealant 10 are positioned on the same plane, of the projection portion 24, respectively. That is, each of the regions 23 includes first region defined by the side face of the projection portion 24 and second region defined by the end face other than the projection portion 24. Accordingly, the length of each of the regions 23 where the upper substrate 6, the lower substrate 7 and the sealant 10 are positioned on the same plane can be made still longer. If, for example, the display units 2 to 4 are small in size, this is effective in making the length of each of the regions 23 where the upper substrate 6, the lower substrate 7 and the sealant 10 are positioned on the same plane longer.

Accordingly, the liquid crystal can be prevented from entering a region (liquid crystal unnecessary region) 21 outside the display area 20 in the liquid crystal injection process. That is, by making the upper substrate 6, the lower substrate 7 and the sealant 10 exposed on opposite sides of the liquid crystal injection port 22 flush with each other, that is, by providing regions where the upper substrate 6, the lower substrate 7 and the sealant 10 are positioned on a same plane on opposite sides of the liquid crystal injection port 22, the spread of liquid crystal during injection of the liquid crystal can be suppressed so that infiltration of the liquid crystal from opposite sides of the liquid crystal injection port 22 into the region 21 outside the display area 20 due to capillarity can be prevented. Further, by setting the length of the regions 23 where the upper substrate 6, the lower substrate 7 and the sealant 10 are positioned on the same plane on opposite sides of the liquid crystal injection port 22 from the liquid crystal injection port 22 to the above length, the length can be made longer than the liquid crystal spread distance during injection of the liquid crystal so that infiltration of the liquid crystal from opposite sides of the liquid crystal injection port 22 into the region 21 outside the display area 20 due to capillarity can reliably be prevented.

Particularly, the surface roughness Ra of the regions 23 where the upper substrate 6, the lower substrate 7 and the sealant 10 are positioned on the same plane is preferably about 8 μm or less. Accordingly, the liquid crystal spread distance during injection of the liquid crystal can be made shorter so that infiltration of the liquid crystal from opposite sides of the liquid crystal injection port 22 into the region 21 outside the display area 20 due to capillarity can reliably be prevented.

Each of the display units 2 to 4 of the liquid crystal display device 1 described above, that is, each of the display units 2 to 4 of the liquid crystal display device 1 having the regions 23 where the upper substrate 6, the lower substrate 7 and the sealant 10 are positioned on the same plane on opposite sides of the liquid crystal injection port 22 can easily be produced by bonding the upper substrate 6 and the lower substrate 7 by the sealant 10 and then cutting the upper substrate 6, the lower substrate 7 and the sealant 10 simultaneously. Particularly, simultaneous cutting can be made easier by using a plastic film substrate as the upper substrate 6 and the lower substrate 7.

Next, a production example of the display units 2 to 4 included in the liquid crystal display device 1 configured as described above will be described.

First, IZO transparent electrodes are formed on the two polycarbonate (PC) film substrates 6, 7 cut to the size of length and width of about 12 cm×about 12 cm and patterned by etching to form the about 0.24 mm-pitch electrodes 9 in a stripe shape. In this case, the 320 electrodes 9A and 240 electrodes 9B in a stripe shape are formed on the two PC film substrates 6, 7 respectively so that a QVGA display of 320×240 dots can be made (see FIGS. 2 and 3).

Next, the two PC film substrates 6, 7 on which the electrodes 9 are formed are cleaned, and polyimide as an alignment layer is applied to a thickness of about 500 Å and baked at about 150° C. for about 1 hour.

Next, a photoresist is applied to one of the PC film substrates 6 (7), patterned by undergoing a photolithography process and baked at about 150° C. for about 120 minutes to form a structure (spacer) of about 5 μm in height.

Next, the epoxy sealant 10 is applied to a peripheral portion of the other PC film substrate 7 (6) by using a dispenser apparatus. In the present embodiment, as will be described later, since the projection portion 24 is formed, the sealant 10 is applied into a shape as illustrated in FIG. 1 on the side on which the liquid crystal injection port 22 is formed.

Next, the two PC film substrates 6, 7 are bonded and heated at about 160° C. for about 1 hour while being pressed by the force of about 1 kg/cm². Accordingly, the sealant 10 is hardened and the substrates 6, 7 are bonded via the sealant 10. At the same time, the structure is also bonded to the substrates 6, 7, forming a uniform cavity for injection of the liquid crystal.

Next, the projection portion 24 having the liquid crystal injection port 22 and the regions 23 where the PC film substrates 6, 7 and the sealant 10 are positioned on the same plane on opposite sides of the liquid crystal injection port 22 are formed. In this case, the two PC film substrates 6, 7 and the sealant 10 are cut simultaneously into a shape illustrated in FIG. 1 by using a Thomson blade to form the projection portion 24 having the liquid crystal injection port 22 and the regions 23 where the PC film substrates 6, 7 and the sealant 10 are positioned on the same plane on opposite sides of the liquid crystal injection port 22. In the present embodiment, the surface roughness Ra of the regions 23 where the PC film substrates 6, 7 and the sealant 10 are positioned on the same plane is about 4.8 μm. The length (distance) of each of the regions 23 where the PC film substrates 6, 7 and the sealant 10 are positioned on the same plane on opposite sides of the liquid crystal injection port 22 is about 23 mm.

Next, the display area 20 defined by the PC film substrates 6, 7 and the sealant 10 is filled with the liquid crystal (see FIG. 1) by the vacuum injection method. In this case, when the liquid crystal is injected by soaking the liquid crystal injection port 22 in the liquid crystal according to the vacuum injection method, the spread of liquid crystal is suppressed so that infiltration of the liquid crystal into the region 21 outside the display area 20 can be prevented.

Then, after the display area 20 being filled with the liquid crystal, though not illustrated, the liquid crystal injection port 22 is sealed by a sealant.

In this manner, each of the display units 2 to 4 of the liquid crystal display device 1 configured as described above can be produced.

Therefore, according to a liquid crystal display device according to the present embodiment, the liquid crystal can be prevented from entering the region 21 outside the display area 20 so that costs can advantageously be reduced and also quality and reliability can be improved.

That is, according to the present liquid crystal display device, in the liquid crystal injection process in which the display area 20 is filled with the liquid crystal by the vacuum injection method, infiltration of the liquid crystal into the region 21 outside the display area 20 that needs not be filled with the liquid crystal, that is, into the region outside the sealant 10 can be prevented. Accordingly, the cleaning process to wash out an unnecessary liquid crystal after the liquid crystal injection process can be eliminated so that lower costs can be achieved by reducing man-hours and costs. Electrodes are provided in the region 21 outside the display area 20 and if the liquid crystal infiltrates into the region 21 and remains there, corrosion of electrodes or terminals will be caused by aging, but because infiltration of the liquid crystal into the region 21 can be prevented, corrosion of electrodes or terminals caused by aging can be prevented. As a result, quality and reliability can be improved.

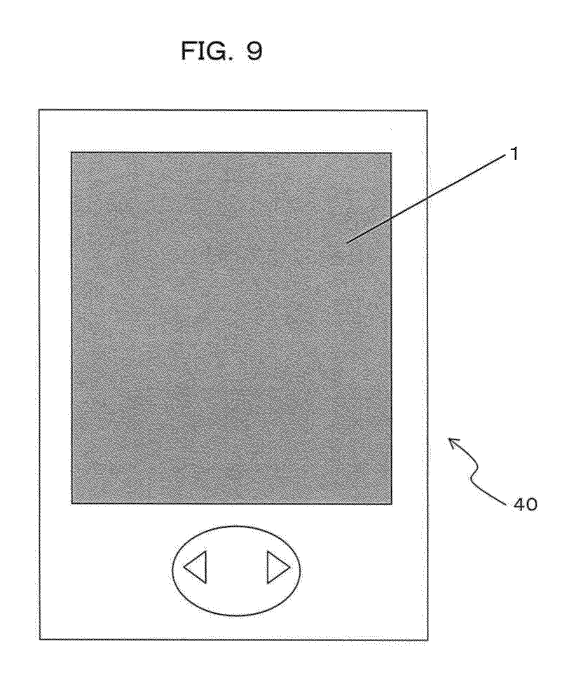

Incidentally, electronic paper as a liquid crystal display device according to the above embodiment can be used for information terminals such as electronic books, sub-displays of mobile terminals and display units of IC cards. In this case, as illustrated, for example, in FIG. 9, an information terminal 40 includes electronic paper (liquid crystal display device 1) according to the above embodiment as a display unit to display desired images. Accordingly, highly reliable information terminals can be realized at low costs. The information terminal may also be called a mobile terminal, portable terminal, portable information terminal, terminal equipment, or portable equipment.

The present invention is not limited to configurations described in the above embodiment and a modification and can be modified in various ways without deviating from the scope of the present invention.

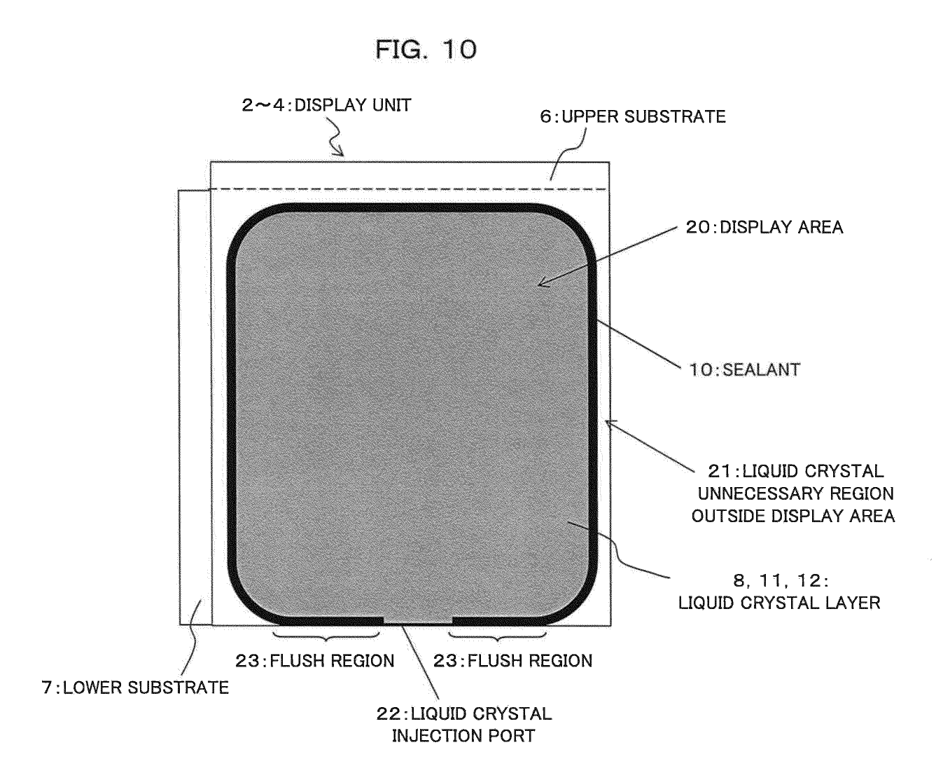

In the above embodiment, for example, each of the display units 2 to 4 of the liquid crystal display device 1 is configured to include the projection portion 24, but the above embodiment is not limited to such an example and, for example, as illustrated in FIG. 10, each of the display units 2 to 4 may be configured not to include the projection portion 24. That is, the upper substrate 6, the lower substrate 7 and the sealant 10 on opposite sides of the liquid crystal injection port 22 are positioned on the same plane, and the upper substrate 6, the lower substrate 7 and the sealant 10 on opposite sides of the liquid crystal injection port 22 and the liquid crystal injection port 22 may be positioned on the same plane.

Also in this case, the upper portion of the liquid crystal injection port 22 is defined by the end face of the upper substrate 6, the lower portion thereof is defined by the end face of the lower substrate 7 and each of side portions thereof is defined by the end face of the sealant 10. Then, the upper substrate 6, the lower substrate 7 and the sealant 10 are exposed on opposite sides of the liquid crystal injection port 22 of the display units 2 to 4 of the liquid crystal display device 1, and the upper substrate 6, the lower substrate 7 and the sealant 10 sandwiched between the substrates 6, 7 are made flush. Then, the length of each of regions 23 where the upper substrate 6, the lower substrate 7 and the sealant 10 are flush with each other from the liquid crystal injection port 22 is a length of about 0.26e^{0.64Ra} (mm) or more, where the surface roughness of the regions 23 where the upper substrate 6, the lower substrate 7 and the sealant 10 are flush is Ra (μm). That is, the upper substrate 6, the lower substrate 7 and the sealant 10 on opposite sides of the liquid crystal injection port 22 are made to be positioned on the same plane and the length of each of the regions 23 where the upper substrate 6, the lower substrate 7 and the sealant 10 are positioned on the same plane from the liquid crystal injection port 22 is set a length of about 0.26e^{0.64Ra} (mm) or more, where the surface roughness of the regions 23 where the upper substrate 6, the lower substrate 7 and the sealant 10 are positioned on the same plane is Ra (μm). Accordingly, the liquid crystal can be prevented from entering the region 21 outside the display area 20 in the liquid crystal injection process. That is, by making the upper substrate 6, the lower substrate 7 and the sealant 10 exposed on opposite sides of the liquid crystal injection port 22 flush with each other, the spread of liquid crystal during injection of the liquid crystal can be suppressed so that infiltration of the liquid crystal from opposite sides of the liquid crystal injection port 22 into the region 21 outside the display area 20 due to capillarity can be prevented. Further, by setting the length of the regions 23 where the upper substrate 6, the lower substrate 7 and the sealant 10 are positioned on the same plane on opposite sides of the liquid crystal injection port 22 from the liquid crystal injection port 22 to the above length, the length can be made longer than the liquid crystal spread distance during injection of the liquid crystal so that infiltration of the liquid crystal from opposite sides of the liquid crystal injection port 22 into the region 21 outside the display area 20 due to capillarity can reliably be prevented. Also in this case, the surface roughness Ra of the regions 23 where the upper substrate 6, the lower substrate 7 and the sealant 10 are positioned on the same plane is preferably about 8 μm or less. Accordingly, the liquid crystal spread distance during injection of the liquid crystal can be made shorter so that infiltration of the liquid crystal from opposite sides of the liquid crystal injection port 22 into the region 21 outside the display area 20 due to capillarity can reliably be prevented.

Each of the display units 2 to 4 of the liquid crystal display device 1 according to such a modification, that is, each of the display units 2 to 4 of the liquid crystal display device 1 having the regions 23 where the upper substrate 6, the lower substrate 7 and the sealant 10 are positioned on the same plane on opposite sides of the liquid crystal injection port 22 can easily be produced by bonding the upper substrate 6 and the lower substrate 7 by the sealant 10 and then cutting the upper substrate 6, the lower substrate 7 and the sealant 10 simultaneously. Particularly, simultaneous cutting can be made easier by using a plastic film substrate as the upper substrate 6 and the lower substrate 7.

Next, a production example of the display units 2 to 4 included in the liquid crystal display device 1 according to such a modification will be described.

First, IZO transparent electrodes are formed on the two polycarbonate (PC) film substrates 6, 7 cut to the size of length and width of about 24 cm×about 24 cm and patterned by etching to form the 0.48 mm-pitch electrodes 9 in a stripe shape. In this case, the 320 electrodes 9A and 240 electrodes 9B in a stripe shape are formed on the two PC film substrates 6, 7 respectively so that a QVGA display of 320×240 dots can be made (see FIGS. 2 and 3).

Next, the two PC film substrates 6, 7 on which the electrodes 9 are formed are cleaned, and polyimide as an alignment layer is applied to a thickness of about 500 Å and baked at about 150° C. for about 1 hour.

Next, a photoresist is applied to one of the PC film substrates 6 (7), patterned by undergoing a photolithography process and baked at about 150° C. for about 120 minutes to form a structure (spacer) of about 5 μm in height.

Next, the epoxy sealant 10 is applied to a peripheral portion of the other PC film substrate 7 (6) by using a dispenser apparatus. In the present modification, the projection portion 24 in the above embodiment is not provided and thus, the sealant 10 is applied into a shape as illustrated in FIG. 10 excluding a region where the liquid crystal injection port 22 is formed.

Next, the two PC film substrates 6, 7 are bonded and heated at about 160° C. for about 1 hour while being pressed by the force of about 1 kg/cm². Accordingly, the sealant 10 is hardened and the substrates 6, 7 are bonded via the sealant 10. At the same time, the structure is also bonded to the substrates 6, 7, forming a uniform cavity for injection of the liquid crystal.

Next, the liquid crystal injection port 22 and the regions 23 where the PC film substrates 6, 7 and the sealant 10 are positioned on the same plane on opposite sides of the liquid crystal injection port 22 are formed. In this case, the two PC film substrates 6, 7 and the sealant 10 are cut simultaneously into a shape illustrated in FIG. 10 by using a ring cutter to form the liquid crystal injection port 22 and the regions 23 where the PC film substrates 6, 7 and the sealant 10 are positioned on the same plane on opposite sides of the liquid crystal injection port 22. In the present modification, the surface roughness Ra of the regions 23 where the PC film substrates 6, 7 and the sealant 10 are positioned on the same plane is about 7.2 μm. The length (distance) of each of the regions 23 where the PC film substrates 6, 7 and the sealant 10 are positioned on the same plane on opposite sides of the quid crystal injection port 22 is about 48 mm.

Next, the display area 20 defined by the PC film substrates 6, 7 and the sealant 10 is filled with the liquid crystal (see FIG. 10) by the vacuum injection method. In this case, when the liquid crystal is injected by soaking the liquid crystal injection port 22 in the liquid crystal according to the vacuum injection method, the spread of liquid crystal is suppressed so that infiltration of the liquid crystal into the region outside the display area can be prevented.

Then, after the display area 20 being filled with the liquid crystal, though not illustrated, the liquid crystal injection port 22 is sealed by a sealant

In this manner, each of the display units 2 to 4 of the liquid crystal display device 1 according to above modification can be produced.

The above embodiment and modification are described by taking the liquid crystal display device using the cholesteric liquid crystal as an example, but are not limited to the cholesteric liquid crystal. For example, the present invention can be applied to a liquid crystal display device using other liquid crystal materials such as the nematic liquid crystal, ferroelectric liquid crystal, and anti-ferroelectric liquid crystal and a similar effect can naturally be obtained in such cases.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A liquid crystal display device comprising:
a first substrate;
a second substrate opposite to the first substrate;
a sealant provided between the first substrate and the second substrate to define a display area to be filled with a liquid crystal; and
a liquid crystal injection port defined by the first substrate, the second substrate and the sealant, wherein
regions where the first substrate, the second substrate and the sealant are positioned on a same plane are provided on opposite sides of the liquid crystal injection port, each of the regions where the first substrate, the second substrate and the sealant are positioned on the same plane having a length equal to 0.26e^{0.64Ra} (mm) or more from the liquid crystal injection port, where surface roughness of the regions where the first substrate, the second substrate and the sealant are positioned on the same plane is Ra (μm).

2. The liquid crystal display device according to claim 1, wherein the surface roughness Ra is 8 μm or less.

3. The liquid crystal display device according to claim 1, further comprising: a projection portion defined by the first substrate, the second substrate and the sealant, and having the liquid crystal injection portion at an end thereof, wherein
the regions where the first substrate, the second substrate and the sealant are positioned on the same plane include side faces, where the first substrate, the second substrate and the sealant are positioned on the same plane, of the projection portion, respectively.

4. The liquid crystal display device according to claim 1, wherein the first substrate, the second substrate and the sealant on opposite sides of the liquid crystal injection port and the liquid crystal injection port are positioned on the same plane.

5. The liquid crystal display device according to claims 1, wherein the first and second substrates are plastic film substrates.

6. A information terminal comprising:
a liquid crystal display device, wherein
the liquid crystal display device includes:
a first substrate;
a second substrate opposite to the first substrate;
a sealant provided between the first substrate and the second substrate to define a display area to be filled with a liquid crystal; and
a liquid crystal injection port defined by the first substrate, the second substrate and the sealant, wherein
regions where the first substrate, the second substrate and the sealant are positioned on a same plane are provided on opposite sides of the liquid crystal injection port, each of the regions where the first substrate, the second substrate and the sealant are positioned on the same plane having a length equal to 0.26e^{0.64Ra} (mm) or more from the liquid crystal injection port, where surface roughness of the regions where the first substrate, the second substrate and the sealant are positioned on the same plane is Ra (μm).

7. The information terminal according to claim 6, wherein the surface roughness Ra is 8 μm or less.

8. The information terminal according to claim 6, wherein the liquid crystal display device includes a projection portion defined by the first substrate, the second substrate and the sealant, and having the liquid crystal injection port at an end thereof, and
the regions where the first substrate, the second substrate and the sealant are positioned on the same plane include side faces, where the first substrate, the second substrate and the sealant are positioned on the same plane, of the projection portion, respectively.

9. The information terminal according to claim 6, wherein the first substrate, the second substrate and the sealant on opposite sides of the liquid crystal injection port and the liquid crystal injection port are positioned on the same plane.

10. The information terminal according to claim 6, wherein the first and second substrates are plastic film substrates.

11. The liquid crystal display device according to claim 2, further comprising: a projection portion defined by the first substrate, the second substrate and the sealant, and having the liquid crystal injection portion at an end thereof, wherein
the regions where the first substrate, the second substrate and the sealant are positioned on the same plane include side faces, where the first substrate, the second substrate and the sealant are positioned on the same plane, of the projection portion, respectively.

12. The liquid crystal display device according to claim 2, wherein the first substrate, the second substrate and the sealant on opposite sides of the liquid crystal injection port and the liquid crystal injection port are positioned on the same plane.

13. The liquid crystal display device according to claims 2, wherein the first and second substrates are plastic film substrates.

14. The liquid crystal display device according to claims 3, wherein the first and second substrates are plastic film substrates.

15. The liquid crystal display device according to claims 4, wherein the first and second substrates are plastic film substrates.

16. The information terminal according to claim 7, wherein the liquid crystal display device includes a projection portion defined by the first substrate, the second substrate and the sealant, and having the liquid crystal injection port at an end thereof, and
the regions where the first substrate, the second substrate and the sealant are positioned on the same plane include side faces, where the first substrate, the second substrate and the sealant are positioned on the same plane, of the projection portion, respectively.

17. The information terminal according to claim 7, wherein the first substrate, the second substrate and the sealant on opposite sides of the liquid crystal injection port and the liquid crystal injection port are positioned on the same plane.

18. The information terminal according to claim 7, wherein the first and second substrates are plastic film substrates.

19. The information terminal according to claim 8, wherein the first and second substrates are plastic film substrates.

20. The information terminal according to claim 9, wherein the first and second substrates are plastic film substrates.
